(19) United States
(12) Patent Application Publication
(10) Pub. No.: US 2019/0344312 A1
(43) Pub. Date: Nov. 14, 2019

(54) WORKSTATIONS FOR PROCESSING MATERIAL INTO COMPONENTS

(71) Applicant: Gary Palmer, Winchester Bay, OR (US)

(72) Inventor: Gary Palmer, Winchester Bay, OR (US)

(21) Appl. No.: 16/392,804

(22) Filed: Apr. 24, 2019

Related U.S. Application Data
(60) Provisional application No. 62/671,313, filed on May 14, 2018.

(51) Int. Cl. B07C 7/00; A47B 37/00; A47B 13/08; A47B 9/10

(52) U.S. Cl. CPC B07C 7/00; A47B 9/10; A47B 13/088; A47B 37/00

(57) ABSTRACT

Workstations including a base, a basin supported on the base for processing material into components, a mounting bracket attached to the basin, and a container with an opening for collecting a desired component of the material processed in the basin, the container being removably attached to the mounting bracket in a position where the opening is adjacent to the basin.

### CROSS REFERENCE TO RELATED APPLICATIONS

This application claims priority to copending U.S. Application Ser. No. 62/671,313, filed on May 14, 2018, which is hereby incorporated by reference for all purposes.

### BACKGROUND

The present disclosure relates generally to workstations. In particular, workstations for processing material into components are described.

Processing material into components is a labor intensive undertaking often requiring considerable skill and concentration. Agricultural products are one type of material routinely processed into components. One form of agricultural product, cannabis, is currently experiencing rapid growth. Processing cannabis includes trimming cannabis flowers into different components and separating the components.

Trimming cannabis and separating the resulting components is one of the final steps involved in yielding a successful cannabis harvest. Proper technique and equipment is critical to the trimming and separation process. The consequences of improper trimming techniques include loss of product, damage to extractable trim, increased labor costs, and repetitive use injuries in workers.

Workstations facilitate manually processing material into components by providing a surface on which to process the material and to sort the components. However, known workstations for processing material into components are not entirely satisfactory for the range of applications in which they are employed. For example, existing workstations fail to provide an effective work surface for trimming cannabis and separating the resulting components.

Most commonly, workstations available for trimming cannabis resemble general purpose tables providing a basic work surface on which to trim the cannabis with separate containers next to or on top of the table. The trimmer must then manually transfer the various product streams and waste streams to each container, one at a time, and inefficiently. Flat, basic work surfaces further lack features to help manage, sort, and collect components.

Conventional workstations fail to include effective ergonomic features for persons using the workstation. For example, existing workstations generally lack padded surfaces on which a person can rest his or her arms more comfortably and with less risk of injury than a rigid surface. Another limitation of known workstations is their lack of height adjustability.

Thus, there exists a need for workstations that improve upon and advance the design of known workstations. Examples of new and useful workstations relevant to the needs existing in the field are discussed below.

### SUMMARY

The present disclosure is directed to workstations including a base, a basin supported on the base for processing material into components, a mounting bracket attached to the basin, and a container with an opening for collecting a desired component of the material processed in the basin, the container being removably attached to the mounting bracket in a position where the opening is adjacent to the basin.

### BRIEF DESCRIPTION OF THE DRAWINGS

FIG. 1 is a perspective view of a workstation and a person addressing the workstation from a standing position.

FIG. 2 is a side view of the workstation shown in FIG. 1 depicting a base supporting a processing unit of the workstation at a standing height in solid lines and at a sitting height in dashed lines.

FIG. 3 is a top view of the workstation shown in FIG. 1 depicting plant material to be processed in a basin, a desired component in a first container, and another component in a second container.

FIG. 4 is a top view of the workstation shown in FIG. 1 depicting the first container and the second container detached from the basin and depicting obscured components in dashed lines.

FIG. 5 is a front elevation view of the workstation shown in FIG. 1.

FIG. 6 is a rear elevation view of the workstation shown in FIG. 1.

FIG. 7 is a perspective view of a tray configured to mount in the basin and to separate components of the material based on size.

FIG. 8 is a perspective view of the workstation shown in FIG. 1 with the tray mounted in the basin and lids mounted to the first and second containers to increase the effective flat area of the workstation.

### DETAILED DESCRIPTION

The disclosed workstations will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various workstations are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The workstations shown in the figures and discussed below function to facilitate processing material into components and to facilitate collecting one or more of the resulting components. Processing material into components often yields a desired component or multiple desired components. The material processing operation also typically yields a waste or less desired component.

As will be explained in more detail below, the workstation facilitates processing material into components and collecting the components by providing one or more processing features and one or more collection features. The processing features and the collection features are arranged relative to each other to cooperate effectively, efficiently, and ergonomically. The workstation further facilitates processing material and collecting components by adjusting the height of the work surface to suit the needs or preferences of a user.

The workstations described herein address the shortcomings existing with conventional workstations. For example, the present workstations provide a work surface with features that enable material to be processed more effectively and for the resulting components to be more effectively sorted and collected. In particular, the present workstations provide one or more containers integrated with adjacent working areas, including a basin and/or a flat work surface, to easily move components to the one or more containers.

The currently described workstations further address the ergonomic deficiencies present in conventional workstations. For example, the workstations disclosed herein are height adjustable to accommodate different workers and working needs. Further, the present workstations provide padded surfaces to make working conditions more comfortable and to reduce the likelihood of injuries resulting from prolonged weight bearing contact with rigid surfaces. The orientation of the processing features and collection features in the workstations discussed here also significantly improve upon the ergonomics of existing workstations.

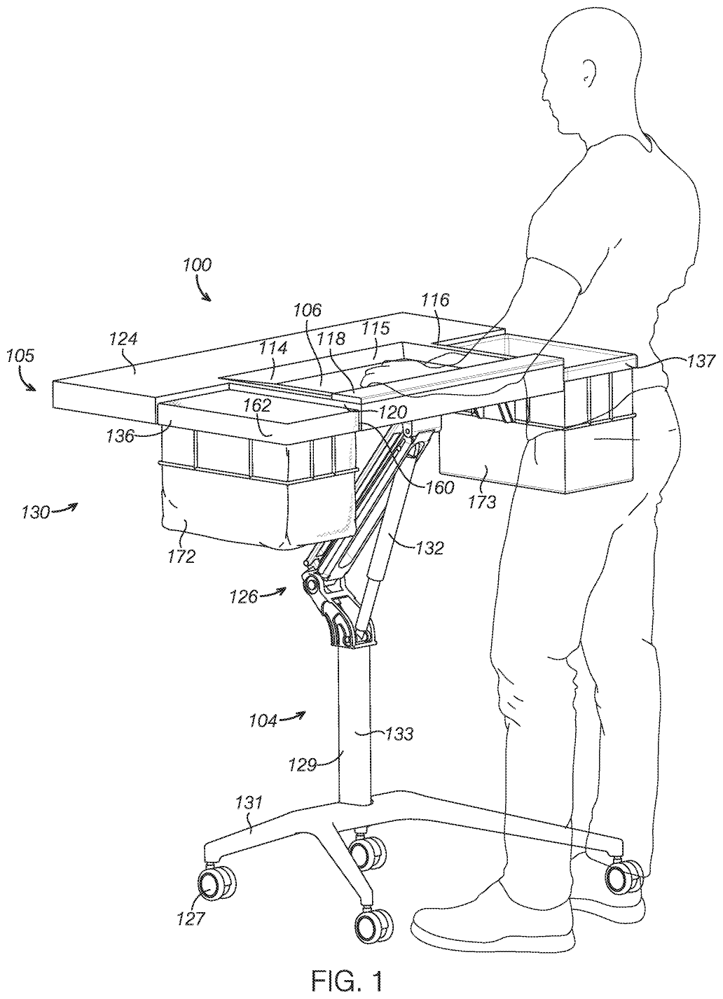

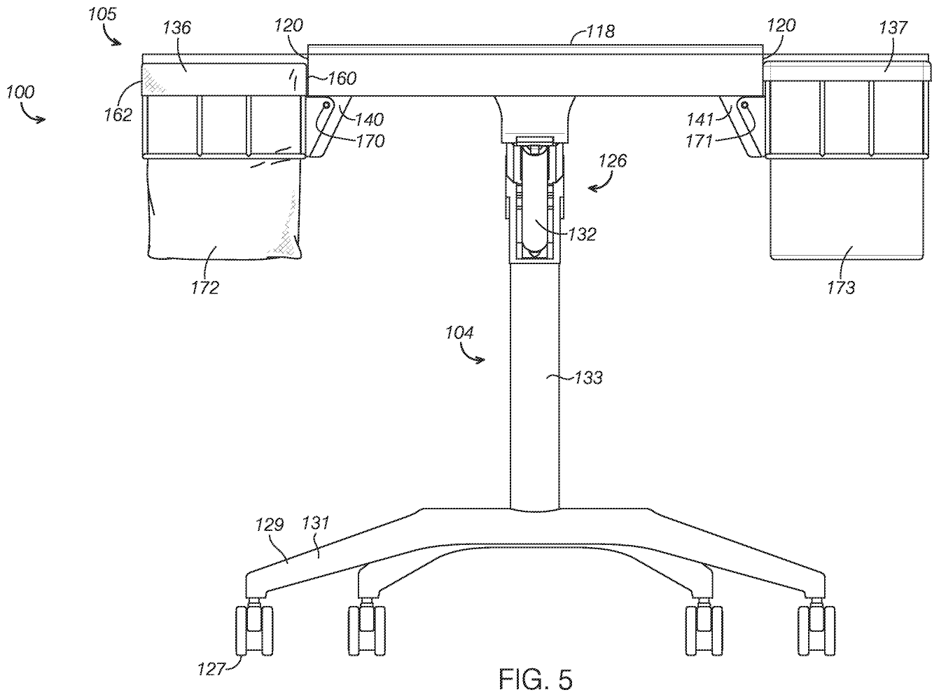

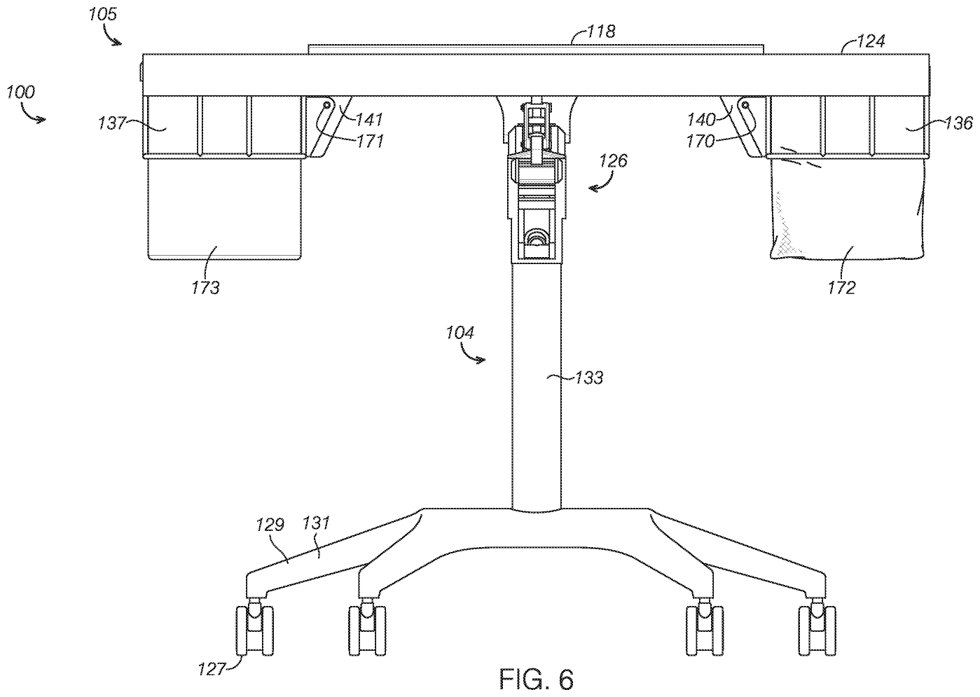

With reference to FIGS. 1-8, a first example of a workstation, workstation 100, will now be described. Workstation 100 includes a base 104, a basin 106, two mounting brackets 140 and 141, two containers 136 and 137, a cushion 118, and a work surface 124. Basin 106, mounting brackets 140 and 141, containers 136 and 137, cushion 118, and work surface 124 may be collectively referred to as a processing unit 105. As can be seen in FIGS. 1-6, and 8, processing unit 105 is supported on base 104.

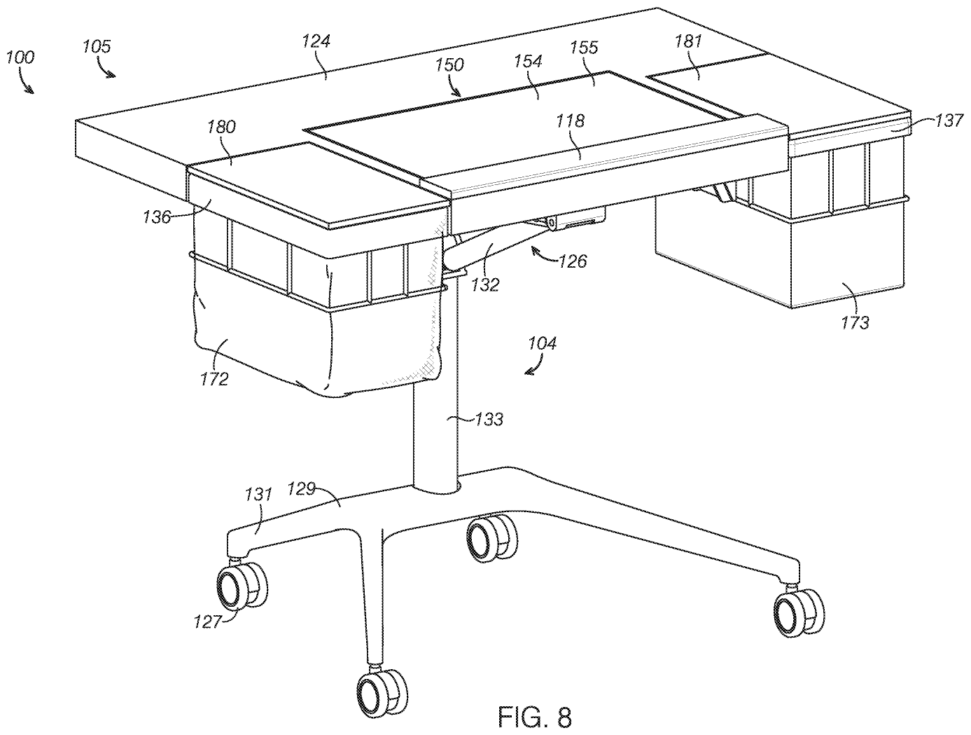

In other examples, the workstation includes different components and/or different numbers of components. For example, some workstation examples do not include a cushion, a tray, and/or a work surface. In certain examples, a single mounting bracket and container are provided, while in other examples, more than two mounting brackets and containers are provided. In some examples, the workstation does not include a basin, includes multiple basins, or, as shown in FIG. 8, has a covered basin to provide a flat surface.

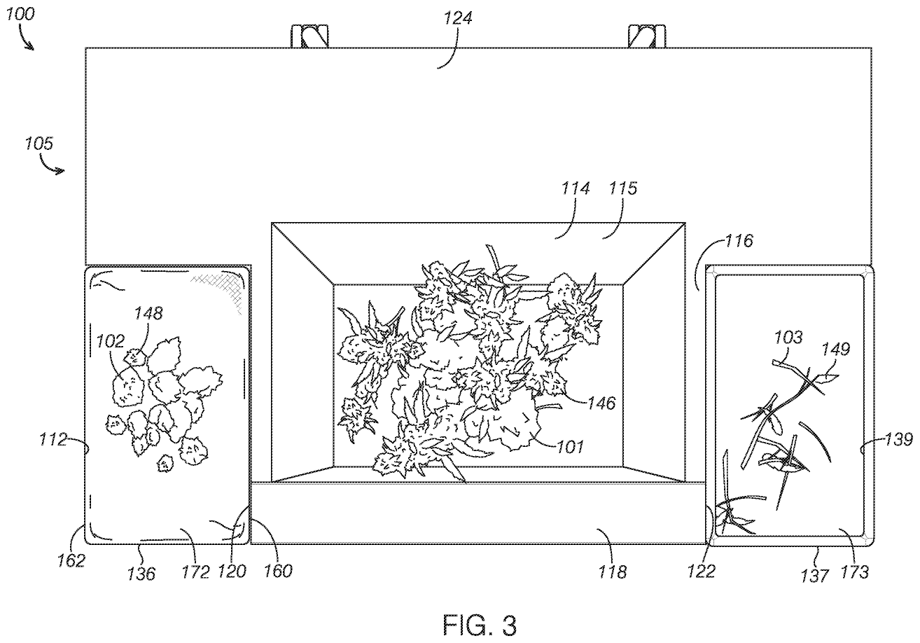

As shown in FIG. 3, workstation 100 functions to process a material 101 into components, including a desired component 102 and a second component 103. In the particular example shown in FIG. 3, material 101 is a portion of a cannabis plant 146, desired component 102 is a bud 148 of cannabis plant 146, and second component 103 is excess foliage 149. In other examples, different materials are processed into components, such as soybeans, corn, wheat, fruit, and nuts.

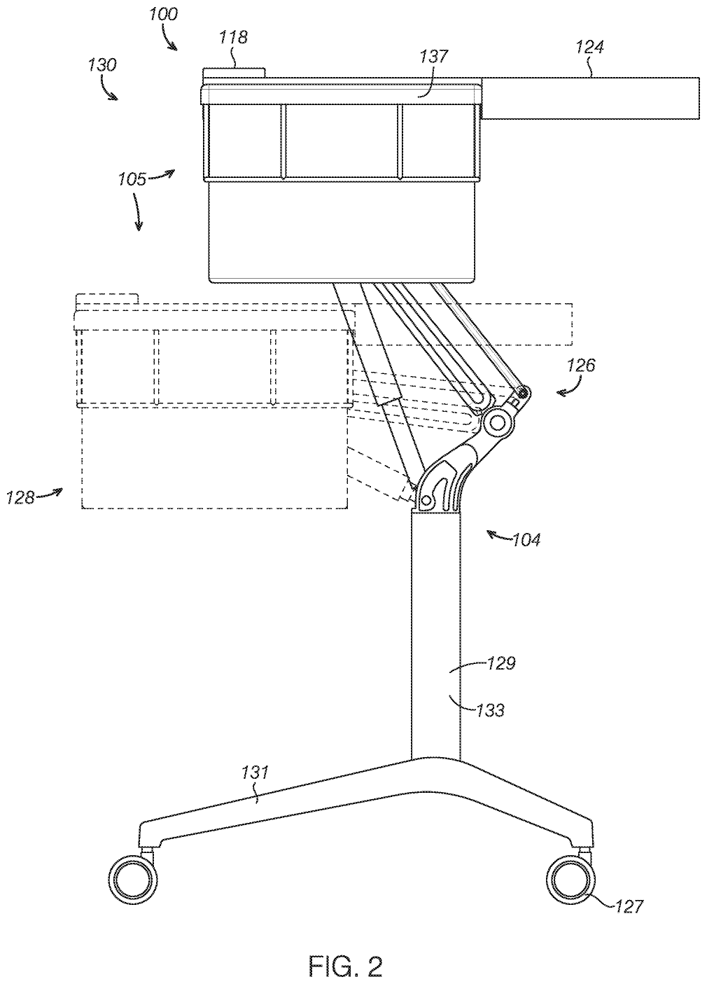

With reference to FIGS. 1 and 2, the reader can see that workstation 100 also functions to raise and lower its height between a seated position 128 and a standing position 130. In particular, workstation 100 is configured to raise and lower processing unit 105. In seated position 128, processing unit 105 is at a height suitable for a person to address workstation 100 while seated. In standing position 130, processing unit 105 is at a height suitable for a person to address workstation 100 while standing.

Base

As can be seen in FIGS. 1, 2, 4-6, and 8, base 104 includes wheels 127, platform 129, and height adjustment mechanism 126. In certain examples, the base includes wheel locks to restrict the wheels, a tilt mechanism to tilt the processing unit relative to the base, and a rotation mechanism to rotate the processing unit relative to the base. In some examples, the base does not include wheels and instead includes fixed feet at the end of the platform. In still further examples, the base does not include a height adjustment mechanism.

Wheels 127 assist to move workstation 100 to a desired position. In the present example, platform 129 includes a stem 133 and four legs 131, and workstation 100 includes four wheels 127 at the end of each of legs 131. In other examples, the platform includes a different number of legs and a different number of wheels, such as three legs and three wheels or five or more legs and five or more wheels. In some examples, one or more of the legs does not include a wheel while the other legs do include wheels. In examples where one or more of the legs does not end in a wheel, the legs without wheels rest on the ground and the legs with wheels rest on the wheels.

Height adjustment mechanism 126 functions to raise and lower the height of processing unit 105, including the height of basin 106, mounting brackets 140 and 141, containers 136 and 137, cushion 118, and work surface 124. As shown in FIGS. 1 and 2, height adjustment mechanism 126 is configured to raise and lower the height of processing unit 105 between seated position 128 and standing position 130. In seated position 128, processing unit 105 is at a height suitable for a person to address workstation 100 while seated. In standing position 130, processing unit 105 is at a height suitable for a person to address workstation 100 while standing.

As shown in FIGS. 1, 2, 4, 5, and 8, height adjustment mechanism 126 includes a hydraulic cylinder 132 and other supporting mechanical components to raise and lower workstation 100 between seated position 128 and standing position 130. Additionally or alternatively to height adjustment mechanism 126, any currently known or later developed components for raising and lowering work surfaces may be used, including manually operated lift systems and electronically operated lift systems.

Basin

As can be seen in FIGS. 1, 3, and 5, basin 106 is supported on base 104 and allows for conveniently processing material 101 into components. In the present example, workstation 100 includes a single basin, basin 106. In other examples, the workstation includes multiple basins, such as to process different materials or to process different components of a material. In some examples, the workstation does not include a basin or includes a cover or tray with a flat surface, such as tray 150 with flat member 154 as shown in FIG. 8, to restrict or prevent material from being placed in the basin and to instead provide a flat working surface.

As shown in FIG. 3, basin 106 includes a bowl 114 in which material 101 may be placed. Bowl 114 is concave to facilitate receiving and manipulating material 101 with reduced likelihood that material 101 will inadvertently be moved out of bowl 114, such as to fall on the floor or to inadvertently be moved to one of containers 136 and 137.

In the present example, bowl 114 is rectangular with planar, sloped walls 115. In some examples, the bowl adopts a different shape, such as circular, oval, triangular, another regular polygon, or an irregular shape. In certain examples, the walls of the bowl are curved instead of planar.

As shown in FIGS. 1, 3, and 5, basin 106 includes a lip 116 surrounding a portion of bowl 114. In the present example, lip 116 surrounds three of four sides of bowl 114, including the two sides proximate containers 136 and 137 and the side proximate where a user would address workstation 100 as shown in FIG. 1.

In the present example, the portion of lip 116 proximate the user supports cushion 118 on which a user may rest his or her arms. In particular, as shown in FIGS. 1 and 3-5, cushion 118 extends from a first lateral end 120 of basin 106 to a second lateral end 122 of basin 106. In other examples, the cushion extends along a portion of the length of the lip proximate the user rather than the entire length between first lateral end 120 and second lateral end 122. In some examples, the workstation does not include a cushion.

In some examples, the lip surrounds the entire bowl or surrounds a smaller portion of the bowl than shown in the present example. For instance, in examples where the workstation includes a single container, the lip may be limited to just the portion of the bowl proximate the container. The lip disposed proximate the user is optional. Thus, in examples where the workstation includes two containers, the lip may surround just two of four sides of the bowl, namely, the two sides proximate the two containers. In some examples, the basin does not include a lip. In such examples, the opening of the basin abuts the one or more containers.

Containers

As shown in FIG. 3, container 136 defines an opening 112 for collecting desired component 102 of material 101 processed in basin 106. Similarly, container 137 defines a second opening 139 and is shown in FIG. 3 receiving second component 103.

Container 137 is configured similarly to container 136 except that container 136 includes fabric walls 172 whereas container 137 includes metal walls 173. The walls of the container may be any currently known or later developed, including plastic, metal, metal mesh, canvas, fabric, and ceramic. For the sake of brevity, the structure of container 136 will be described in detail and the reader should understand that the structure for container 137 is the same or substantially similar.

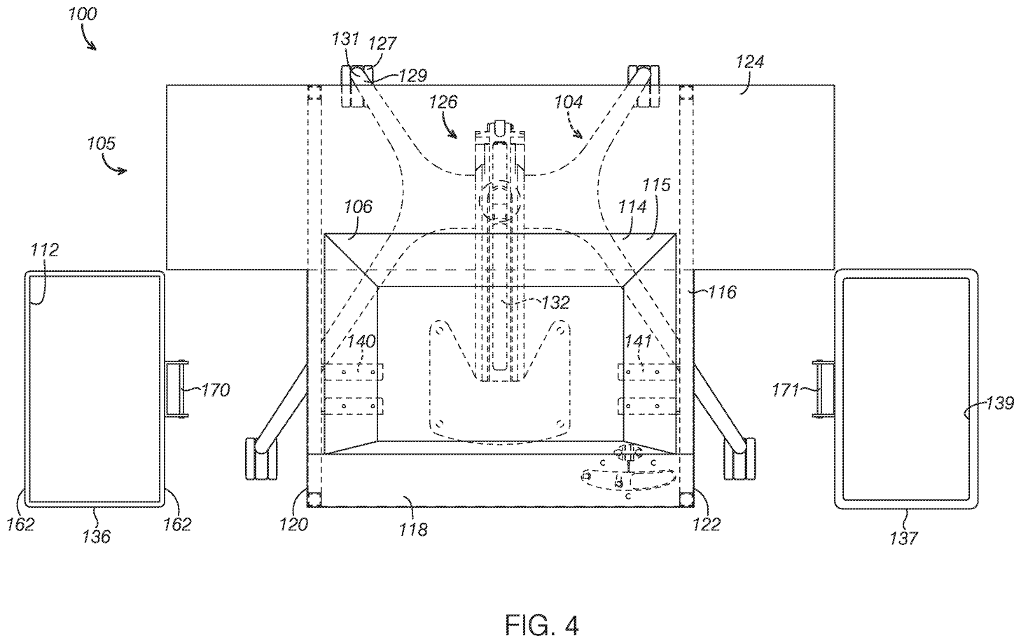

As shown in FIG. 4, containers 136 and 137 are removably attached to mounting brackets 140 and 141, respectively, which are explained in more detail below. With reference to FIGS. 1, 3-6, and 8, the reader can see that container 136 is removably attached to mounting bracket 140 in a position where opening 112 is adjacent to basin 106. Similarly, second container 137 is removably attached to second mounting bracket 141 in a position where second opening 139 is adjacent to basin 106. In particular, first container 136 is supported by mounting bracket 140 in a position abutting lip 116 of basin 106 and second container 137 is supported by mounting bracket 141 in a position abutting lip 116 of basin 106.

Mounting Brackets

As can be seen in FIGS. 4-6, mounting brackets 140 and 141 are attached to basin 106 and receive complimentary engagement members 170 and 171, respectively, attached to containers 136 and 137, respectively. Second mounting bracket 141 is mounted to basin 106 opposite first mounting bracket 140. Through the cooperation of mounting bracket 140 and engagement member 170, container 136 is selectively mounted to basin 106 adjacent lip 116. Likewise, through the cooperation of mounting bracket 141 and engagement member 171, container 137 is selectively mounted to basin 106 adjacent lip 116.

The figures show that mounting bracket 140 supports container 136 in a position where opening 112 of container 136 is at substantially the same height as lip 116 to facilitate desired component 102 falling into container 136 when moved from bowl 114 beyond lip 116 towards container 136. Similarly, mounting bracket 141 supports container 137 in a position where opening 139 of container 137 is at substantially the same height as lip 116 to facilitate moving second component 103 into container 137. In some examples, the mounting brackets support the containers at a position where the openings are at a height lower than the height of the lip. As long as the height of the openings is at or below the height of the lip, a user may easily move components from the basin into the containers.

Work Surface

As the reader can see in FIGS. 1-6 and 8, work surface 124 is adjacent to basin 106, container 136, and to container 137. FIG. 1 demonstrates that, in the present example, work surface 124 is adjacent to basin 106 in a position distal where a user addresses workstation 100. In other examples, a portion of the work surface is proximate the user or the work surface is entirely proximate the user.

In the present example, work surface 124 extends across the entire lateral dimension of workstation 100. The reader can see in FIGS. 3 and 4 that work surface 124 extends from lateral end 122 of basin 106 to second lateral end 162 of container 136 and beyond when container 136 is mounted to mounting bracket 140. In some examples, the work surface extends a shorter distance across the workstation, such as across the lateral dimension (or width) of the basin only or less than the full lateral dimension of the basin.

In workstation 100, work surface 124 is integrally connected to basin 106. In other examples, the work surface is attached to the basin with fasteners, such as mechanical fasteners, adhesives, or hook-and-loop fasteners. In some examples, the work surface is attached to the baisn by magnetic attraction or by welding.

The reader can see in the figures that work surface 124 provides a flat surface on which material, components, tools, or other objects can be placed. The flat surface of work surface 124 is also suitable for processing material 101 into components.

In the example shown in FIG. 8, the reader can see that lids 180 and 181 may be provided on containers 136 and 137, respectively, to effectively extend the flat surface of work surface 124. Lids 180 and 181 are flat metal plates complimentarily configured with containers 136 and 137, but could be any suitable material currently known or later developed.

With further reference to FIG. 8, the reader can see that flat member 154 of tray 150 resting in basin 106 may further effectively extend the flat surface of work surface 124. In other examples, a lid complimentarily configured with the basin is provided rather than utilizing a flat surface of the tray.

Tray

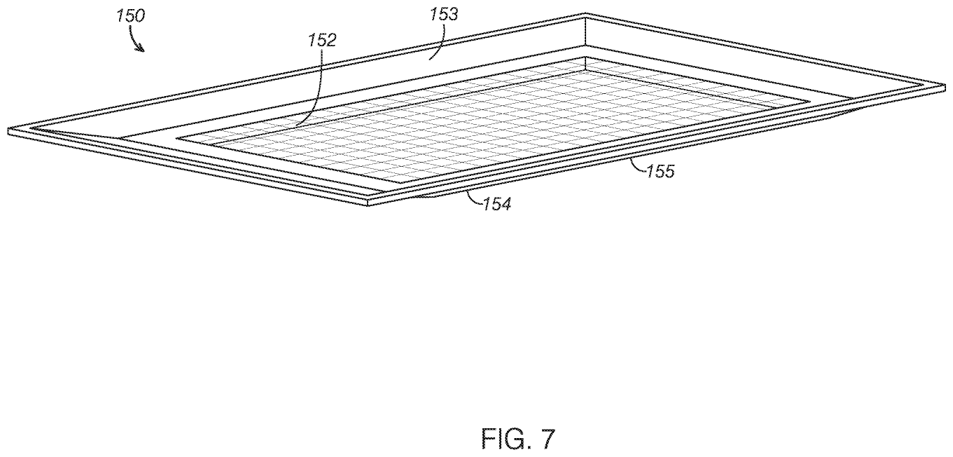

As shown in FIG. 7, tray 150 includes a screen 152, a frame 153, and flat member 154. Screen 152 and flat member 154 are supported by frame 153 in a vertically spaced, substantially coplanar orientation. Flat member 154 is configured to selectively slide out of frame 153 for purposes of accessing particles collected on flat member 154.

In the present example, tray 152 is complimentarily configured with basin 106 to enable tray 150 to rest in bowl 114. In a sorting orientation, tray 150 rests in basin 106 with screen 152 vertically above flat member 154. In a cover orientation, tray 150 rests in basin 106 with flat member 154 vertically above screen 152.

Screen 152 defines a mesh configured to allow particles of material 101 below a threshold size to pass through screen 152 and to retain on screen 152 particles of material 101 above the threshold size. The screen may be any suitable mesh size for a given sorting application. In some examples, the tray includes a sieve instead of or in addition to a screen. The hole sizes of the sieve may be any size and shape suitable for allowing particles of a selected size to pass through the sieve and to retain particles larger than the selected size.

In the sorting orientation, material 101 is placed on screen 152 and smaller particles fall through screen 152 and collect on flat member 154. In the cover orientation, a flat surface 155 of flat member 154 is substantially coplanar with lip 116 of basin 106 to effectively extend the flat surface of work surface 124.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A workstation for processing material into components, including a desired component, and for collecting the desired component, comprising:
a base;
a basin supported on the base for processing the material into components;
a mounting bracket attached to the basin; and
a container with an opening for collecting the desired component of the material processed in the basin, the container being removably attached to the mounting bracket in a position where the opening is adjacent to the basin.

2. The workstation of claim 1, wherein the basin includes a bowl and a lip surrounding a portion of the bowl.

3. The workstation of claim 2, wherein the mounting bracket supports the container in a position where the opening of the container is at substantially the same height as the lip to enable the desired component to fall into the container when moved from the bowl beyond the lip towards the container.

4. The workstation of claim 2, further comprising a cushion mounted to the lip of the basin in a position proximate where a user addresses the workstation.

5. The workstation of claim 4, wherein the cushion extends from a first lateral end of the basin to a second lateral end of the basin.

6. The workstation of claim 2, further comprising a tray complimentarily configured with the basin and supported by the basin, the tray including a screen to allow particles of the material below a threshold size to pass through the screen and to retain on the screen particles of the material above the threshold size.

7. The workstation of claim 6, wherein:
the tray includes a flat member with a flat surface; and
the tray and the basin are complimentarily configured such that the tray may rest in the bowl of the basin with the flat surface of the flat member of the tray being substantially coplanar with the lip of the basin.

8. The workstation of claim 1, wherein the container is supported by the mounting bracket in a position abutting the basin.

9. The workstation of claim 1, further comprising a work surface adjacent to the basin.

10. The workstation of claim 9, wherein the work surface is adjacent to the basin in a position distal where a user addresses the workstation.

11. The workstation of claim 10, wherein:
the basin includes a first lateral end distal the container;
the container includes a first lateral end proximate the basin and a second lateral end distal the basin; and
the work surface extends from at least the first lateral end of the basin to the second lateral end of the container.

12. The workstation of claim 9, wherein the work surface is integrally connected to the basin.

13. The workstation of claim 1, wherein the base includes a height adjustment mechanism to raise and lower the height of the basin.

14. The workstation of claim 13, wherein the height adjustment mechanism is configured to raise and lower the height of the basin between a seated position at a height suitable for a person to address the workstation while seated and a standing position at a height suitable for a person to address the workstation while standing.

15. The workstation of claim 13, wherein the height adjustment mechanism includes a hydraulic cylinder.

16. The workstation of claim 1, wherein the base includes wheels to assist moving the workstation.

17. The workstation of claim 1, wherein the container defines a first container, the opening defines a first opening, the mounting bracket defines a first mounting bracket, and the workstation further comprises:
a second mounting bracket mounted to the basin opposite the first mounting bracket, and
a second container defining a second opening, the second container being removably attached to the second mounting bracket in a position where the second opening is adjacent to the basin.

18. The workstation of claim 1, wherein the container includes fabric walls.

19. The workstation of claim 1, wherein the material processed is a portion of a cannabis plant.

20. The workstation of claim 19, where the desired component is a bud of the portion of the cannabis plant trimmed of excess foliage.
